(19) United States
(12) Patent Application Publication
(10) Pub. No.: US 2016/0160090 A1
(43) Pub. Date: Jun. 9, 2016

(54) Adhesive Arrangement

(71) Applicant: Tyco Electronics Corporation, Berwyn, PA (US)

(72) Inventors: Lei Wang, San Jose, CA (US); Hyo Chang Yun, Saratoga, CA (US); Peter J. Dutton, Fremont, CA (US)

(73) Assignee: Tyco Electronics Corporation, Berwyn, PA (US)

(21) Appl. No.: 14/560,391

(22) Filed: Dec. 4, 2014

(51) Int. Cl. C09J 7/02; B32B 27/32; B32B 15/08; B32B 27/08; B32B 7/12; B32B 15/04

(52) U.S. Cl. CPC C09J 7/0267; B32B 7/12; B32B 15/043; B32B 15/08; B32B 27/08; B32B 27/322; B32B 2250/02; B32B 2307/54; B32B 2307/542

(57) ABSTRACT

An adhesive arrangement includes an adhesive formed from an adhesive composition having a thermoplastic material and a melt-processable perfluoropolymeric material. The adhesive arrangement further includes a base layer in contact with the adhesive. The thermoplastic material is polyetherimide (PEI), polyphenylenesulfide (PPS), polyaryletherketone (PAEK) including polyetheretherketone (PEEK), polyamide (PA), and/or polysulfone derivatives including polysulfone. The base layer is a perfluoropolymeric material, a composite material, a metal material, a metallic material, another suitable material, or a combination thereof.

### FIELD OF THE INVENTION

The present invention is generally directed to adhesives. More particularly, the present invention is directed to adhesive arrangements having at least one layer in contact with an adhesive blend.

### BACKGROUND OF THE INVENTION

Perfluoropolymer, such as, polytetrafluoroethylene (PTFE) are difficult to bond to due to their low surface energy, high crystallinity, symmetric structure, and chemical resistance. To address this, surface treatments, such as, chemical etching, plasma treating, or fire burning, are used. Bonding to metals is easier than perfluoropolymers. However, adhesives capable of bonding a metal to a perfluoropolymer surface suffer from the same difficulties, in part due to the difficulty in bonding to perfluoropolymers and in part due to the differences in surface energy of metal (around 2 J/m²) and the surface energy of PTFE (around 0.02 J/m²).

Certain applications are not suitable for surface treatment. For example, repair environments can be incompatible with the operational needs of surface treatment techniques.

An adhesive arrangement that shows one or more improvements in comparison to the prior art would be desirable in the art.

### BRIEF DESCRIPTION OF THE INVENTION

In an embodiment, an adhesive arrangement includes an adhesive formed from an adhesive composition, the adhesive composition having a thermoplastic material selected from the group consisting of polyetherimide (PEI), polyphenylenesulfide (PPS), polyaryletherketone (PAEK) including polyetheretherketone (PEEK), polyamide (PA), polysulfone derivatives including polysulfone, and combinations thereof, and having a melt-processable perfluoropolymeric material, and a base layer in contact with the adhesive, the base layer being a perfluoropolymeric material, a composite material, a metal material, or a metallic material.

In another embodiment, an adhesive arrangement includes an adhesive formed from an adhesive composition, a base layer in contact with the adhesive, the base layer being a perfluoropolymeric material, and a polytetrafluoroethylene (PTFE) layer in contact with the adhesive and secured to the base layer by the adhesive.

In another embodiment, an adhesive arrangement includes an adhesive formed from an adhesive composition, the adhesive composition having a thermoplastic material consisting of polyetherimide (PEI) and a melt-processable perfluoropolymeric material consisting of one or both of perfluoroalkoxy (PFA) and fluorinated ethylene propylene (FEP), and a base layer in contact with the adhesive, the base layer being a perfluoropolymeric material.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a schematic view of a section view of an adhesive arrangement defining a tube, according to an embodiment of the disclosure.

Wherever possible, the same reference numbers will be used throughout the drawings to represent the same parts.

### DETAILED DESCRIPTION OF THE INVENTION

Provided is an adhesive arrangement. Embodiments of the present disclosure, for example, in comparison to concepts failing to include one or more of the features disclosed herein, permit an adhesive blend to bond to low surface energy materials without relying upon surface treatment, permit bonding with perfluoropolymers (for example, polytetrafluoroethylene (PTFE)), permit bonding with metals (for example, steel and aluminum), permit bonding between two layers of the same materials (for example, bonding aluminum to aluminum, bonding steel to steel, bonding PTFE to PTFE), permit bonding two different materials (for example, bonding aluminum to PTFE, bonding aluminum to steel, bonding PTFE to steel), permit an increase in shear strength of bonded materials, permit other features and advantages that are apparent in the present disclosure, or a combination thereof.

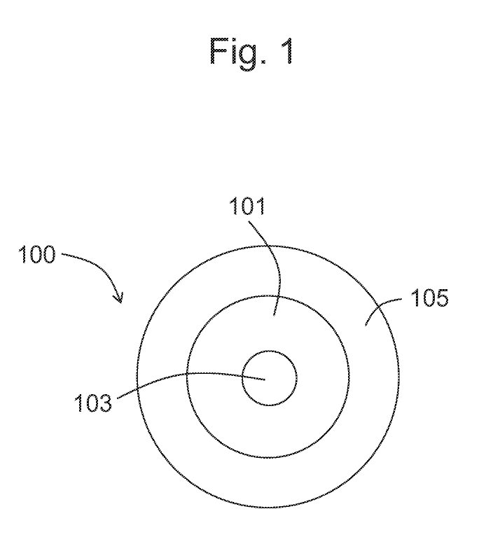

Referring to FIG. 1, an adhesive arrangement 100 includes an adhesive blend 101 and a base layer 103. In further embodiments, the adhesive arrangement 100 includes an adhering layer 105 directly or indirectly secured to the base layer 103 by the adhesive blend 101. The base layer 103 is a perfluoropolymeric material (for example, polytetrafluoroethylene), a composite material, a metal material, or a metallic material. The adhering layer 105 is the same material as the base layer 103 or is a different material from the base layer 103. Other embodiments include one or more additional layers, such as, tie layers, transition layers, external layers, internal layers, or combinations thereof. Additionally or alternatively, in other embodiments, the adhesive blend 101 is present in one or more of the layers and/or abutting other adhesive layers, for example, as a gradient or transition.

In one embodiment, the base layer 103 and/or the adhering layer 105 are in direct contact with the adhesive blend 101, for example, being devoid of tie layers. Additionally or alternatively, in one embodiment, the base layer 103 and/or the adhering layer 105 are devoid or substantially devoid of surface characteristics from surface treatment, for example, by being devoid of surface morphology corresponding to plasma treatment (for example, by being devoid of a graft-polymerization layer, by being devoid of hydrophilicity corresponding with plasma treatment, and/or by being devoid of the near planar surface corresponding with plasma treatment), by being devoid of surface morphology corresponding to sodium-in-liquid-ammonium treatment (for example, by being devoid of chemical damage from such etching, by not being brown, and/or by not losing an optical penetration property), being devoid of surface restructuring from firing, or by being devoid of chemical or physical properties corresponding with surface treatment.

The adhesive blend 101 is formed from an adhesive composition. The adhesive composition includes a thermoplastic material and a melt-processable perfluoropolymeric material. In one embodiment, the thermoplastic materials are polyetherimide (PEI), polyphenylenesulfide (PPS), polyetheretherketone (PEEK), polyamide (PA), polyaryletherketone (PAEK), polysulfone, or a combination thereof. In one embodiment, the melt-processable perfluoropolymeric material is or includes one or both of perfluoroalkoxy (PFA) and fluorinated ethylene propylene (FEP). In one embodiment, the thermoplastic material is or includes polyetherimide (PEI), polyphenylenesulfide (PPS), polyaryletherketone (PAEK) including polyetheretherketone (PEEK), polyamide (PA), and/or polysulfone derivatives including polysulfone.

In one embodiment, the thermoplastic material is at a concentration, by volume, of between 10% and 80%, between 10% and 50%, between 10% and 35%, between 20% and 40%, between 30% and 40%, or any suitable combination, sub-combination, range, or sub-range therein.

In one embodiment, the melt-processable perfluoropolymeric material is at a concentration, by volume, of between 20% and 90%, between 50% and 90%, between 65% and 90%, between 60% and 80%, between 60% and 70%, or any suitable combination, sub-combination, range, or sub-range therein.

The adhesive blend 101 permits the adhesive arrangement 100 to have a select tensile strength. For example, depending upon the materials being adhered and the composition of the adhesive blend 101, the tensile strength is at least 0.5 MPa, at least 1 MPa, at least 2.5 MPa, at least 3 MPa, at least 5 MPa, at least 8 MPa, at least 9 MPa, between 2 MPa to 10 MPa, a select percent above a relative tensile strength of PFA (for example, at least 5% greater, at least 10% greater, at least 15% greater, at least 20% greater, at least 30% greater, at least 100% greater, at least 200% greater, and/or at least 300% greater) or any suitable combination, sub-combination, range, or sub-range therein.

The adhesive blend 101 and/or the adhesive arrangement 100 further include any suitable features for desired properties. For example, in embodiments with reinforcement being desired, the adhesive blend 101 is capable of including reinforcing particles, such as, reinforcing fibers and/or carbon fibers.

The adhesive arrangement 100 is positioned in, forms a portion of, or defines any suitable structure/article benefiting from adhesive properties, such as, the shear strength achievable by the adhesive blend 101. Suitable structures/articles include, but are not limited to, adhesively-coupled tubes/sleeves, joints, gauges, wires, marine components, other structures/articles, or a combination thereof.

### EXAMPLES

Several samples are prepared by mixing materials at 30 revolutions per minutes for 5 minutes, then 80 revolutions per minute for 10 minutes. Film samples are prepared by compression molding using 152 mm×152 mm×0.60 mm metal frames. Polymeric blends are positioned between two films of PTFE or polyimide and two steel plates press into the film samples under select temperatures and pressures. The film samples are peeled off and tested for shear test.

In a first example, shear strengths of perfluoropolymer adhesives and fluoropolymer adhesives bonding PTFE to PTFE are tested. The shear strength of PFA is about 3.19 MPa, shear strength of PTFE is about 2.59 MPa, the shear strength of fluorinated ethylene propylene (FEP) is about 2.18 MPa, the shear strength of tetrafluoroethylene-co-hexafluoropropylene-co-vinylidene fluoride terpolymer (THV) is about 1.57 MPa or 0.68 MPa (depending upon whether THV 815 or THV 2030, respectively), the shear strength of ethylene tetrafluoroethylene (ETFE) is about 0.52 MPa, the shear strength of ethylene chlorotrifluoroethylene (ECTFE) is about 0.55 MPa, and the shear strength of polyvinylidene fluoride (PVDF) is about 0.18 MPa. The perfluoropolymer adhesives show higher compatibility and form an entanglement layer easier. The fluoropolymer adhesives show lower compatibility and less thermal stability.

In a second example, according to an embodiment of the disclosure, shear strengths of several adhesive blends bonding PTFE to PTFE are tested. The blends include the thermoplastic material and the melt-processable perfluoropolymeric material, specifically, PFA, at various concentrations having the following shear strengths:

TABLE 1

| | Shear | Shear | Shear |
|---|---|---|---|
| | Strength | Strength | Strength |
| | with | with | with |
| | balance | balance | balance |
| PFA | PEI | PPS | PEEK |
| (vol. %) | (in MPa) | (in MPa) | (in MPa) |
| 80 | 3.07 | 3.35 | 2.95 |
| 70 | 2.67 | 2.67 | 2.47 |
| 60 | 1.38 | 1.46 | 0.97 |
| 50 | 0.86 | 0.61 | 0.89 |
| 40 | 0.60 | 0.48 | |
| 25 | 0.64 | | |

At 80%, by volume, loading of the PFA, each of the adhesive blends results in desirable shear strengths.

In a third example, according to an embodiment of the disclosure, shear strengths of several adhesive blends bonding aluminum to aluminum are tested. The blends include the thermoplastic material and the melt-processable perfluoropolymeric material, specifically, PFA, at various concentrations having the following shear strengths:

TABLE 2

| | Shear | Shear | Shear |
|---|---|---|---|
| | Strength | Strength | Strength |
| | with | with | with |
| | balance | balance | balance |
| PFA | PEI | PPS | PEEK |
| (vol. %) | (in MPa) | (in MPa) | (in MPa) |
| 80 | 9.08 | 8.62 | 8.44 |
| 70 | 7.67 | 7.97 | 6.62 |
| 60 | 7.88 | 5.96 | 0.80 |
| 50 | 6.60 | 4.07 | 3.58 |
| 40 | 6.79 | 2.46 | |
| 25 | 9.68 | | |
| 0 | 9.59 | 1.35 | 7.46 |

The thermoplastic materials impact adhesion different from each other, overall showing a substantial increase in comparison to PFA, specifically, within the range of 20% to 30%, by volume, being the thermoplastic material.

In a fourth example, according to an embodiment of the disclosure, shear strengths of several adhesive blends bonding PTFE to aluminum are tested. The blends include the thermoplastic material and the melt-processable perfluoropolymeric material, specifically, PFA, at various concentrations having the following shear strengths:

TABLE 3

| | Shear | Shear | Shear |
|---|---|---|---|
| | Strength | Strength | Strength |
| | with | with | with |
| | balance | balance | balance |
| PFA | PEI | PPS | PEEK |
| (vol. %) | (in MPa) | (in MPa) | (in MPa) |
| 80 | 1.43 | 1.47 | 1.54 |
| 70 | 1.63 | 1.51 | 1.50 |
| 60 | 1.00 | 1.17 | 0.91 |
| 50 | 0.83 | | 0.20 |
| 40 | | 0.08 | |

In comparison, PFA at 100%, by volume, has a shear strength of bonding PTFE to aluminum of 0.49 MPa. The thermoplastic materials impact adhesion different from each other, overall showing a substantial increase in comparison to PFA, specifically, within the range of 20% to 40%, by volume, being the thermoplastic material.

In a fifth example, according to an embodiment of the disclosure, shear strengths of several adhesive blends bonding steel to steel are tested. The blends include the thermoplastic material and the melt-processable perfluoropolymeric material, specifically, PFA, at various concentrations having the following shear strengths:

TABLE 4

| | Shear |
|---|---|
| | Strength |
| | with |
| | balance |
| PFA | PEI |
| (vol. %) | (in MPa) |
| 80 | 11.16 |
| 60 | 10.46 |
| 40 | 14.56 |
| 0 | 13.73 |

The adhesive blends show a substantial increase in comparison to PFA, especially, at about 60%, by volume, being the PEI.

In a sixth example, according to an embodiment of the disclosure, shear strengths of several adhesive blends bonding steel to PTFE are tested. The blends include the thermoplastic material and the melt-processable perfluoropolymeric material, specifically, PFA, at various concentrations having the following shear strengths:

TABLE 5

| | Shear |
|---|---|
| | Strength |
| | with |
| | balance |
| PFA | PEI |
| (vol. %) | (in MPa) |
| 80 | 2.91 |
| 70 | 3.08 |
| 60 | 1.43 |
| 50 | 1.34 |

In comparison, PFA at 100%, by volume, has a shear strength of bonding steel to PTFE of 1.44 MPa. The adhesive blends show a substantial increase in comparison to PFA, especially, between 20% and 30%, by volume, being the PEI.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. An adhesive arrangement, comprising:
an adhesive formed from an adhesive composition, the adhesive composition having a thermoplastic material selected from the group consisting of polyetherimide (PEI), polyphenylenesulfide (PPS), polyaryletherketone (PAEK) including polyetheretherketone (PEEK), polyamide (PA), polysulfone derivatives including polysulfone, and combinations thereof, and having a melt-processable perfluoropolymeric material; and
a base layer in contact with the adhesive, the base layer being a perfluoropolymeric material, a composite material, a metal material, or a metallic material.

2. The adhesive arrangement of claim 1, wherein the base layer is devoid of surface characteristics from surface treatment.

3. The adhesive arrangement of claim 1, wherein the thermoplastic material is at a concentration, by volume, of between 10% and 50%.

4. The adhesive arrangement of claim 1, wherein the thermoplastic material is at a concentration, by volume, of between 10% and 35%.

5. The adhesive arrangement of claim 1, wherein the thermoplastic material is the polyetherimide (PEI) and is at a concentration, by volume, of between 10% and 80%.

6. The adhesive arrangement of claim 1, further comprising a polytetrafluoroethylene (PTFE) layer in contact with the adhesive and secured to the base layer by the adhesive.

7. The adhesive arrangement of claim 6, wherein the base layer is the perfluoropolymeric material.

8. The adhesive arrangement of claim 7, wherein the adhesive arrangement has a tensile strength of at least 0.5 MPa.

9. The adhesive arrangement of claim 7, wherein the adhesive arrangement has a tensile strength of at least 1 MPa.

10. The adhesive arrangement of claim 7, wherein the adhesive arrangement has a tensile strength of at least 2.5 MPa.

11. The adhesive arrangement of claim 1, wherein the melt-processable perfluoropolymeric material is selected from the group consisting of perfluoroalkoxy (PFA), fluorinated ethylene propylene (FEP), and combinations thereof.

12. The adhesive arrangement of claim 1, further comprising a perfluoropolymeric layer in contact with the adhesive and secured to the base layer by the adhesive.

13. The adhesive arrangement of claim 1, further comprising a metal layer in contact with the adhesive and secured to the base layer by the adhesive.

14. The adhesive arrangement of claim 1, further comprising a metallic layer in contact with the adhesive and secured to the base layer by the adhesive.

15. The adhesive arrangement of claim 1, wherein the adhesive further comprises reinforcing particles.

16. The adhesive arrangement of claim 1, wherein the adhesive further comprises reinforcing fibers.

17. The adhesive arrangement of claim 1, further comprising an adhering layer adhesively coupled by the adhesive to the base layer, wherein the base layer includes one or more materials from the group of polytetrafluoroethylene (PTFE), aluminum, and steel, wherein the adhering layer includes the one or more materials, and wherein the adhesive arrangement has a property of tensile strength that is at least 5% greater than a relative tensile strength of a pure perfluoroalkoxy (PFA) adhesive arrangement adhesively coupling two relative surfaces of the one or more materials.

18. The adhesive arrangement of claim 1, further comprising an adhering layer adhesively coupled by the adhesive to the base layer, wherein the base layer includes one or more materials from the group of polytetrafluoroethylene (PTFE), aluminum, and steel, and wherein the adhesive arrangement has a property of tensile strength that is at least 200% greater than a relative tensile strength of a pure perfluoroalkoxy (PFA) adhesive arrangement adhesively coupling the one or more materials with a material identical to the adhering layer.

19. An adhesive arrangement, comprising:
an adhesive formed from an adhesive composition;
a base layer in contact with the adhesive, the base layer being a perfluoropolymeric material; and
a polytetrafluoroethylene (PTFE) layer in contact with the adhesive and secured to the base layer by the adhesive.

20. An arrangement according to claim 20 wherein the adhesive composition comprises perfluoroalkoxy (PFA)

21. An adhesive arrangement, comprising:
an adhesive formed from an adhesive composition, the adhesive composition having a thermoplastic material consisting of polyetherimide (PEI) and a melt-processable perfluoropolymeric material consisting of one or both of perfluoroalkoxy (PFA) and fluorinated ethylene propylene (FEP); and
a base layer in contact with the adhesive, the base layer being a perfluoropolymeric material.
